(19) United States
(12) Patent Application Publication
(10) Pub. No.: US 2015/0029592 A1
(43) Pub. Date: Jan. 29, 2015

(54) EDGE-LIT PANEL PROTECTION LAYER

(71) Applicant: GE Lighting Solutions, LLC, East Cleveland, OH (US)

(72) Inventors: Qi LONG, ShangHai (CN); Jie GAO, ShangHai (CN); Jiawei LI, Avon Lake, OH (US); Min FANG, ShangHai (CN)

(21) Appl. No.: 14/339,688

(22) Filed: Jul. 24, 2014

(30) Foreign Application Priority Data
Jul. 26, 2013 (CN) 201310318484.X

(51) Int. Cl. G02B 1/11; B29C 59/04; B29C 45/14; B29C 59/02

(52) U.S. Cl. CPC G02B 1/11; B29C 59/022; B29C 59/04; B29C 45/14336; B29C 45/14778; B29C 2059/023; B29C 2045/0094
USPC 359/601; 264/2.5; 264/1.7

(57) ABSTRACT

Provided is an apparatus for reducing glare in a lighting panel. The apparatus includes a translucent layer having an emitting surface. A microstructure of the emitting surface is formed of features in cooperative arrangement for redirecting light produced by the lighting panel.

### FIELD OF THE INVENTION

The present invention relates generally to edge-lit panel lighting fixtures. More particularly, the present invention relates to controlling light distribution in edge-lit panels to achieve an optimal unified glare rating (UGR).

### BACKGROUND OF THE INVENTION

Edge-lit light emitting diode (LED) panels are becoming an increasingly common technology used, for example, in indoor lighting fixtures. As understood by those of skill in the art, light is transmitted from an LED luminaire array to a central area of an edge-lit panel through light guides.

Among the advantages of edge-lit panels is that they allow the lighting fixture to be very thin. A drawback, however, is that conventional edge-lit panel products cannot control UGR effectively. A result of ineffectively controlled UGR is the production of glare, which can be particularly significant in large rooms. This is particularly true for large rooms, or conference rooms, used in office settings.

In a conventional lighting panel, or luminaire, a diffuser (i.e., an optical protective layer) is used in an outer surface of the LED flat-panel to attempt to make the light output more uniform. In these conventional luminaires, the diffuser typically has a rough surface and includes scattering particles, which diminish the uniformity of the light output.

For example, most LED flat panel products use materials such as poly (methyl methacrylate) (PMMA), polycarbonate (PC), and/or polystyrene (PS), with frosted material. These type diffusers scatter the light produced by the luminaire so that the light distribution for the LED flat-panel is lambertian, or near lambertian. The UGR for these fixtures is routinely high—for example, greater than 20.

The amount of glare consistent with UGR values greater than 20 can be discomforting, especially in the office in room settings noted above. Correspondingly, lighting fixtures with high glare and UGR values have limited utility and desirability in these office settings, in computer-aided design (CAD) workstations, reception areas, and the like.

### SUMMARY OF EMBODIMENTS OF THE INVENTION

Given the aforementioned deficiencies, a need exists for systems and methods for improving the optical performance of edge-lit panel protective layers. Particularly, what are needed are systems and methods for improved diffusers used in the outer surface of LED flat panels to make the light output more uniform.

Embodiments of the present invention provide an apparatus for reducing glare in a lighting panel. The apparatus includes a translucent protective layer having an emitting surface. A microstructure of the emitting surface is formed of features in cooperative arrangement for redirecting light produced by the lighting panel.

In the exemplary embodiments, LED fixtures use optical patterns on the emitting surface of a plastic-like protective layer to control the light distribution of the LED fixture at high angles (>than 60°). By limiting the light output at this high angle, the uncomfortable effects of glare can be controlled to be as low as possible.

In some embodiments, the protective layer is constructed of a totally transparent plastic or low hazed translucent to maximize control of high angle light and glare.

In other embodiments, a protective layer with optical patterns can improve the glare for the LED fixtures using edge-lit and back-lit technology. The protective layer can be made, for example, of plastic or similar material. The optical pattern can be formed of a prism, convex sphere, pyramid or any other suitable shape. Parameters associated with the optical pattern or optimized to produce the lowest glare and UGR levels.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is an illustration of an LED panel lighting fixture in which embodiments of the present invention can be practiced.

FIG. 2 is an illustration of a general structure of an LED panel constructed in accordance with embodiments of the present invention.

FIG. 3 is a sectional view of a light guide, optical layer, and LEDs used in the panel illustration of FIG. 2.

FIG. 4 is an illustration of an exemplary optical protection layer surface pattern constructed in accordance with the embodiments.

FIG. 5 is a more detailed illustration of surface features associated with the exemplary surface pattern of FIG. 4.

FIG. 6 is an illustration of a comparison of optical features associated with different angles used in the exemplary surface pattern of FIG. 4.

FIG. 7 is a graphical illustration of simulation results produced by an exemplary prism surface pattern in accordance with the embodiments.

FIG. 8 is an illustration of additional exemplary protection layer surface patterns in accordance with the embodiments.

FIG. 9 is a tabular summary of simulation results associated with different protection layer surface patterns.

FIG. 10 is a flowchart of an exemplary method of practicing an embodiment of the present invention.

### DETAILED DESCRIPTION OF EMBODIMENTS OF THE INVENTION

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

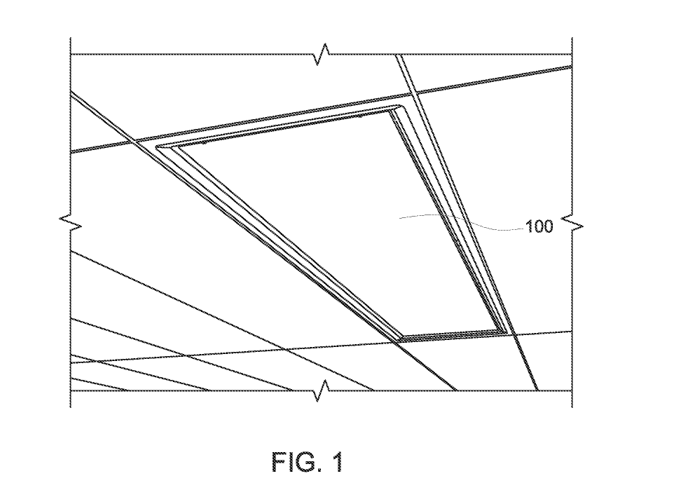

In the embodiments, FIG. 1 is an illustration of a typical LED panel lighting fixture 100 typically used in applications where embodiments of the present invention can be practiced. For example, the LED panel lighting fixture 100 is commonly used in office settings such as conference and meeting rooms, CAD workstations, reception areas, archives, etc. By way of example, and not limitation, the lighting fixture 100 is a 1×4 recessed troffer. The embodiments of the present invention, however, are not limited to a troffer nor to the exemplary panel lighting fixture 100.

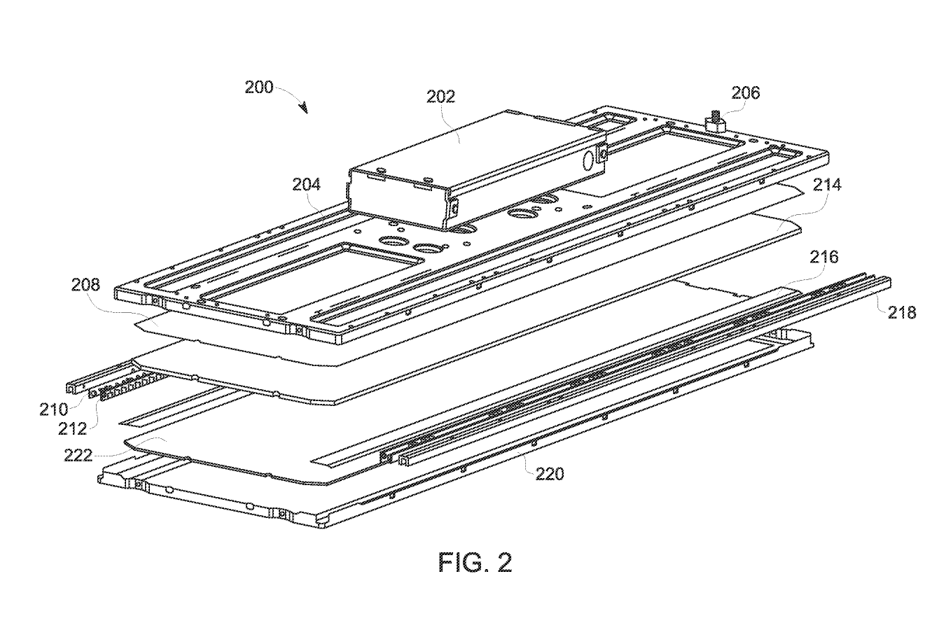

FIG. 2 is an illustration of a general structure of an exemplary LED panel 200 constructed in accordance with embodiments of the present invention. The exemplary LED panel 200 is typically used and systems, such as the LED panel lighting fixture 100 of FIG. 1.

The LED panel 200 standard components, such as a power supply unit (PSU) box 202, which houses the drivers for the panel 200. A back cover 204 serves as an enclosure for all of the other components of the LED panel 200. Also included is an emergency module 206, along with a back reflector 208. An LED bar 210 includes LEDs mounted within corresponding reflector cups 212. The LEDs of the LED bar 210 are positioned to surround a light guide (e.g., waveguide) 214. The light guide 214, via total internal reflection (TIR), directs light produced by the LED bar 210 to areas of the LED panel 200.

Also included are an air gap reflector 216, a heat sink 218, a front bezel 220, and an optical protective layer 222. Optical protective layers are also referred to by those of skill in the art as diffusers. The optical protective layer 222 overlays, or is affixed to, a surface of the light guide 214. The optical protective layer 222 shields the light guide 214 from debris and other contaminants.

During operation of an exemplary embodiment, light from the LED bar 210 is transmitted and dispersed within the light guide 214, where it initially radiates primarily in two directions: up and down.

When the light radiates upwardly, it is subsequently reflected by the back reflector 208 in a downward direction, while being distributed through the optical protective layer 222.

Light that is initially radiated downwardly is directly radiated through the optical protective layer 222. The combination of light beams radiating directly and indirectly through the optical protective layer 222 produces significant high angle (e.g., >60°) light in conventional LED flat panels.

In conventional LED flat panels, the distribution of significant amounts of high angle light renders the UGR level uncontrollable. In the embodiments, however, a surface of the optical protective layer 222 is formed of a pattern (e.g., prism/spherical/pyramid) including features that interact to reduce the high angle light. Reducing the high angle light ultimately results in a lower UGR level and reduced glare.

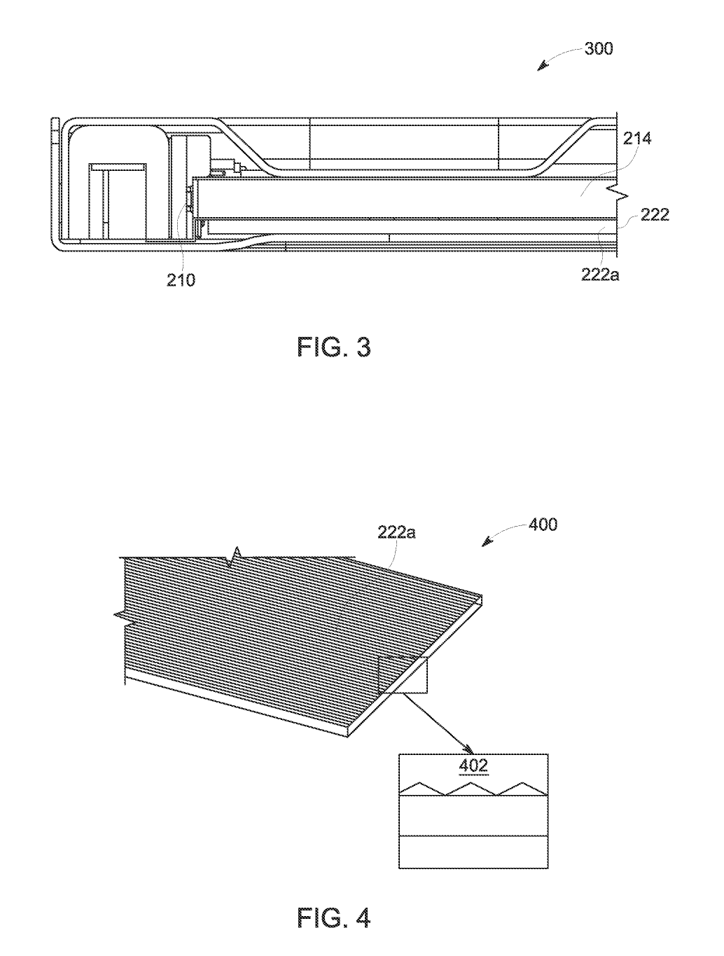

FIG. 3 is a sectional view 300 depicting the positioning of the light guide 214 relative to the optical protective layer 222 and the LED bar 210 in the panel 200. Also shown in FIG. 3 is a surface 222a of the optical protective layer 222.

FIG. 4 is a perspective view 400 of the surface 222a of the exemplary optical protective layer 222, having a pattern imprinted thereon. A subsection 402 of the surface 222a depicts a surface pattern having prism type features, or formations. In the exemplary embodiments, various patterns can be imprinted on the surface 222a. Features of these patterns, as discussed below, are optimized to redirect the light from the light guide 214 more narrowly (i.e., more directionally). More specifically, these pattern features (e.g., prism type) are positioned in cooperative arrangement with respect to one another. That is, the features or formations are positioned on the surface 222a in a manner in which they interact with one another.

When light from all directions is provided by the light guide 214 through the optical layer 222, this light is redirected so the output light will be within a particular beam angle (θ).

This redirection of light from the LED flat-panel 200 helps to reduce glare and lower the UGR levels.

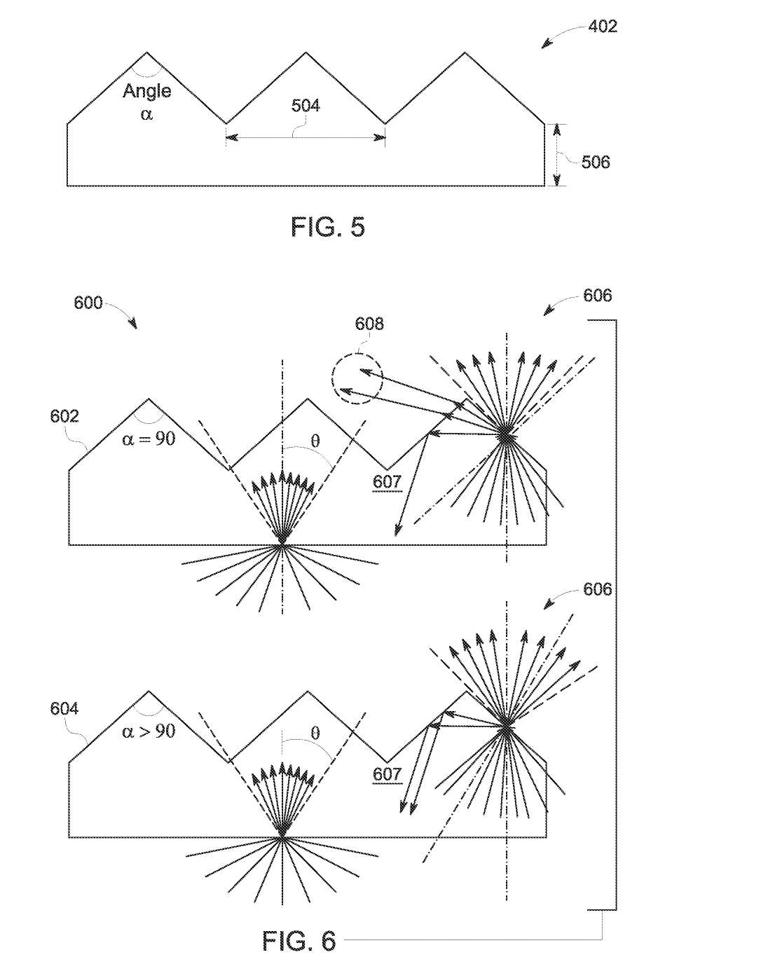

FIG. 5 is a more detailed illustration of the pattern features of the subsection 402 from the surface 222a of the optical protective layer 222. As illustrated in FIG. 5, features of the surface pattern include a pattern top angle (α), a width 504, and a height 506. By adjusting the pattern top angle (α), the width 504, and the height 506 of the surface pattern features, the protective layer 222 can be optimized to reduce the high angle light, and consequently the glare, in various LED flat-panel applications.

FIG. 6 is an illustration of simulation results 600 achieved in two different optical layers, such as the optical layer 222, having different pattern top (α) angles, respectively. Particularly, the simulation results 600 indicate that the higher the pattern top angle (α), the greater the reduction of the high angle light, and subsequently the lower the UGR.

In the example of FIG. 6, the optical layer 222 is constructed of a clear PS with no diffuser particles or frost material. Additionally, and by way of example and not limitation, the beam angle (θ) within the optical layer is set to be within 39°, in the example of FIG. 6, due to refraction law principles. A micro-structure of the pattern (e.g., prism) on the surface 222a of the protective layer 222 is designed to control the direction, and redirection, of light.

In FIG. 6, the simulation results indicate that the top angle (α) of the prism is an important parameter that can significantly affect resulting glare and UGR levels. In FIG. 6, for example, prism patterns 602 and 604 are shown. The prism pattern 602 has a top angle (α) of 90°, with light near normal line 606 and TIR light 607. With the top angle (α) at 90°, the prism pattern 602 produces light at high angle 608. As noted above, greater levels of light at high angle equate to higher levels of glare.

In the example prism pattern 604, by increasing the top angle (α) to >90°, the light at high angle 608 is eliminated. That is, increasing the value of the pattern top angle (α) can reduce the light at high angle, ultimately resulting in lower levels of glare. Different UGR results can be achieved with different pattern top angles (α) using the clear PS material.

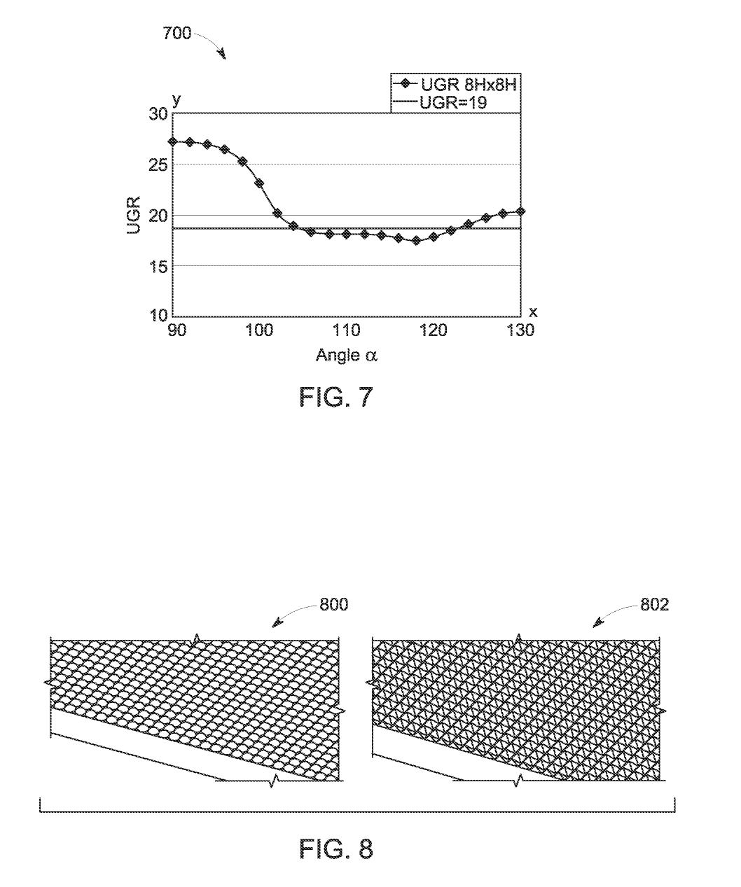

FIG. 7 is a graphical illustration of simulation results 700 representative of different surface pattern top angle (α) values, width 504 values, and height 506 values. Through simulations associated with various embodiments of the present invention that optimized the parametric values above, the inventors of the present application have discovered that a UGR value ≦19 can be achieved when the top angle values are ≧106 and ≦122 are used. These specific values are predicated on the following transfer function:

UGR 8H×8H=241.466−3.84531X+1.65E−02X**2

R−Sq=93.1%

where Y:UGR 8H×8H; X: angle

FIG. 8 is an illustration of additional exemplary protection layer surface patterns 800 and 802, in accordance with the embodiments. Features of the pattern 800 are formed of convex sphere-like structures. Features of the pattern 802 are formed of pyramid-like structures. Although the patterns 800 and 802 are spheres and pyramids respectively, the present invention is not so limited. For example, many other feature shapes and are possible and are within the spirit and scope of the present invention.

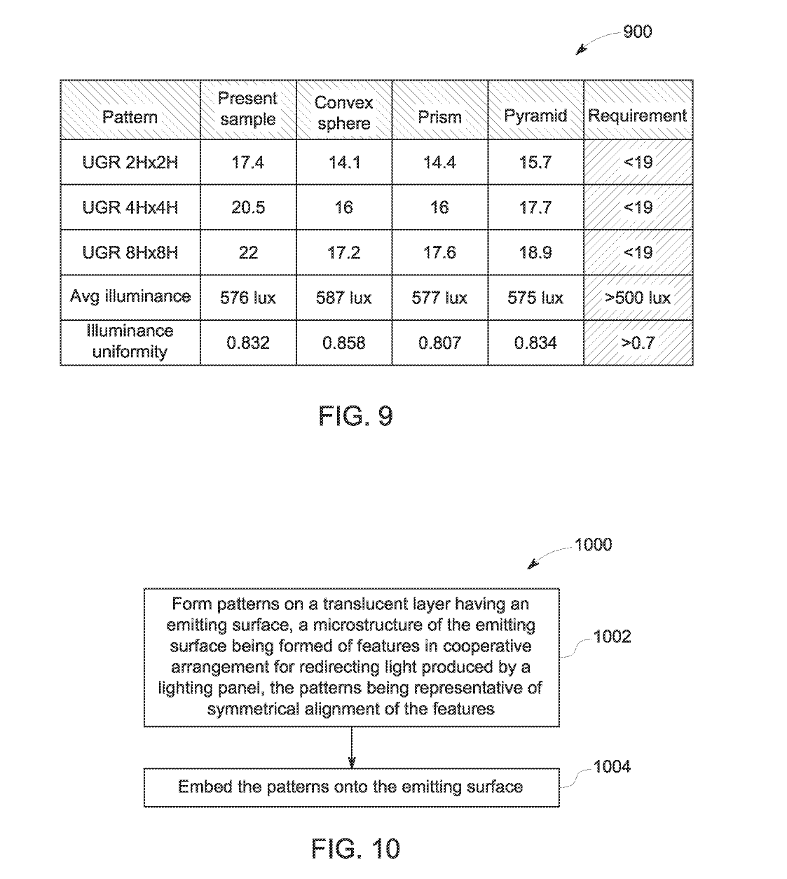

FIG. 9 is a tabular summary 900 of simulation results associated with exemplary sphere, prism, and pyramid protection layer surface patterns. As indicated in the table 900, different (α) values, width 504 values, and height 506 values can be adjusted to optimize light control and achieve UGR and glare levels <19.

In accordance with the embodiments, creating patterns on the surface 222a of the protective optical layer 222 can be achieved using a number of different techniques well known to those of skill in the art.

For example, a roller mechanism, containing features of a desirable pattern, can be produced. Using this approach, once the raw material of the optical protective layer 222 has been selected, the roller mechanism can be used to embed the pattern into the optical protective layer 222.

The patterns can also be embedded into the optical protective layer 222 through injection molding. The roller mechanism process, although relatively inexpensive, is less precise than injection molding.

Although the illustrious embodiments of the present invention, depicted in the drawings use materials, such as PS, PC, and/or PMMA to manufacture the protective optical layer 222, many other materials and plastic derivatives can be used and are within the spirit and scope of the present invention.

FIG. 10 is a flowchart of an exemplary method 1000 of practicing an embodiment of the present invention. In a step 1002, patterns are formed on a translucent layer having an emitting surface, the microstructure of emitting surface being formed of features in cooperative arrangement for redirecting light produced by a lighting panel. The patterns are representative of symmetrical alignment of the features. In step 1004, the patterns are embedded onto the emitting surface.

### DETAILED DESCRIPTION

As noted above, embodiments of the present invention provide an optical layer having embedded patterns there on to optimize the redirection of light produced by LED flat-panel. The more narrowly directed (i.e., redirected) light facilitates the achievement of lower glare and UGR levels. In an embodiment, the optical layer includes prism, sphere, pyramid and/or other suitable structures to achieve enhanced light distribution. Optical protective layers constructed in accordance with the embodiments can redirect the light from the light guide so the light distribution of LED edge-lit flat panels can be changed to achieve better glare and UGR levels.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

For example, various aspects of the present invention can be implemented by software, firmware, hardware (or hardware represented by software such, as for example, Verilog or hardware description language instructions), or a combination thereof. After reading this description, it will become apparent to a person skilled in the relevant art how to implement the invention using other computer systems and/or computer architectures.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. An apparatus for reducing uniform glare rating (UGR) levels in a lighting panel, comprising:
a translucent layer having an emitting surface;
wherein a microstructure of the emitting surface is formed of features in cooperative arrangement for redirecting light produced by the lighting panel.

2. The apparatus of claim 1, wherein the translucent layer substantially reduces high angle light.

3. The apparatus of claim 2, wherein the high angle light includes light radiating through the translucent layer at an angle above about 60°.

4. The apparatus of claim 1, wherein the features are configured to interact with components of the light.

5. The apparatus of claim 1, wherein the cooperative arrangement includes pattern formations.

6. The apparatus of claim 5, wherein the patterns are representative of symmetrical alignment of the features.

7. The apparatus of claim 6, wherein all of the features associated with a particular pattern are uniformly shaped.

8. The apparatus of claim 7, wherein the shapes resemble at least one from the group a prism, a pyramid, and sphere.

9. The apparatus of claim 8, wherein a degree of glare reduction is a function of parameters of the features.

10. The apparatus of claim 9, wherein the parameters include at least one from the group including a pattern top angle, a feature width, and a feature height.

11. The apparatus of claim 1, wherein the lighting panel is an edge-lit panel.

12. The apparatus of claim 1, further comprising a lighting guide.

13. The apparatus of claim 12, wherein the translucent layer is affixed to a surface of the lighting guide.

14. A method of manufacturing a translucent layer configured to reduce glare in a lighting panel, the translucent layer having an emitting surface, a microstructure of the emitting surface being formed of features in cooperative arrangement for redirecting light produced by the lighting panel, the method comprising:
forming a pattern representative of symmetrical alignment of the features; and
embedding the pattern onto the emitting surface.

15. The method of claim 14, wherein all of the features associated with the pattern are uniformly shaped.

16. The method of claim 15, wherein the patterns resemble at least one from the group a prism, a pyramid, and a sphere.

17. The method of claim 16, wherein the forming includes imprinting the pattern onto a roller.

18. The method of claim 17, wherein the embedding includes transferring the pattern from the roller to the emitting surface.

19. The method of claim 18, wherein the embedding includes injecting the pattern onto the emitting surface via injection molding.

20. A computer readable media storing instructions, when said instructions, when executed are adapted to execute a process within a computer system with a method of manufacturing a translucent layer configured to reduce glare in a lighting panel, the translucent layer having an emitting surface, a microstructure of the emitting surface being formed of features in cooperative arrangement for redirecting light produced by the lighting panel, the method comprising:
forming a pattern representative of symmetrical alignment of the features; and
embedding the pattern onto the emitting surface.
